(19) United States
(12) Patent Application Publication
(10) Pub. No.: US 2016/0296865 A1
(43) Pub. Date: Oct. 13, 2016

(54) SLOTTED BASKET FOR THE SOAKING AND STRAINING OF TOWELS, CLOTHS, AND OTHER HARD SURFACE ITEMS

(71) Applicant: Ecolab USA Inc., St. Paul, MN (US)

(72) Inventors: Amie Blanks, Clemmons, NC (US); Melissa Martinez-Crowley, Greensboro, NC (US); Rachel Martin, Greensboro, NC (US)

(21) Appl. No.: 14/681,233

(22) Filed: Apr. 8, 2015

(51) Int. Cl. B01D 35/28; B01D 29/17

(52) U.S. Cl. CPC B01D 35/28; B01D 29/17

(57) ABSTRACT

A straining apparatus for use with a receptacle for the presoaking of items is provided. The straining device is sized such that a floor of the straining device is spaced from a floor of the receptacle to allow for any soils and/or stains of a presoaked item to pass into the receptacle. Therefore, when the items that have been presoaked are to be transferred to a cleaning apparatus, the soils and/or stains will not be transferred and will reside within the receptacle. An annual flange at an upper end of the straining device can rest on an upper rim of the receptacle to position the straining device within the receptacle such that the straining device will be suspended a distance above the receptacle floor. The straining device can also include slots for allowing the soiled solution to pass therethrough.

### FIELD OF THE INVENTION

The invention relates generally to cleaning apparatuses. More specifically, but not exclusively, the invention relates to devices for the soaking and straining of towels, cloths, and other hard surface items.

### BACKGROUND OF THE INVENTION

Cloths, towels, wares, and other hard surface items are used to clean surfaces of different applications, such as retail, industrial, and institutional applications. These items can utilize a cleaning composition to clean up the surfaces, sometimes acquiring stains as well as other soils during the cleaning process. To clean these items, a pre-soak formula can be used to aid in the pretreatment and stain removal of towels and cloths. Such a formula is disclosed in U.S. Pat. No. 8,753,453, hereby incorporated by reference in its entirety.

The common process for cleaning the cloths or towels in the various applications requires that the customer manually remove the towels/cloths from the solution they are soaking in. This is a tedious and dirty task. Customers often pour the soiled solution and the towels/cloths into the washing machine because it is easier. However, doing so can affect the cleaning process, as the dirty solution, including heavy soils, is deposited into the washing machine.

Therefore, there is a need in the art for a tool to aid in the pre-soaking and straining of towels, cloths, and other hard surface items and to reduce the amount of soiled solution that goes into a washing apparatus.

### SUMMARY OF THE INVENTION

Therefore, it is a primary object, feature, and/or advantage of the invention to improve on or overcome deficiencies in the art.

It is another object, feature, and/or advantage of the invention to provide a tool to allow hard surface items to be strained after a pre-soak process to mitigate exposure of soils into a cleaning apparatus.

It is yet another object, feature, and/or advantage of the invention to provide a tool that can be used with existing buckets used to pre-soak hard surface cleaning items.

It is still another object, feature, and/or advantage of the invention to provide a straining device that would allow a user to soak towels and cloths and then easily drain them to eliminate soiled solution from being poured into a washing apparatus.

It is a further object, feature, and/or advantage of the invention to provide a straining tool that fits within a bucket such that the tool is suspended at least partially above a bottom surface of the interior of the bucket.

It is still a further object, feature, and/or advantage of the invention to provide a straining tool that allows for the easy transfer of pre-soaked textiles or other solid surface materials to a cleaning apparatus.

These and/or other objects, features, and advantages of the present invention will be apparent to those skilled in the art. The present invention is not to be limited to or by these objects, features and advantages. No single embodiment need provide each and every object, feature, or advantage.

The invention relates to an apparatus for use with buckets for receiving used objects that are to be pre-soaked in a solution before cleaning in a cleaning apparatus. The apparatus may be a straining tool that can fit at least partially into the bucket in order to allow the soiled object to soak. When the object or objects are to be moved to the cleaning apparatus, the apparatus can be removed from the bucket. Slots in the apparatus will allow the pre-soak solution and any soils to pass through and remain in the bucket so that they will not be included in the cleaning apparatus.

The apparatus may be a straining tool that is a cone or frustum of a cone in shape. The bottom of the tool can include slots and be formed of a concave shape. The frustum shape and concave bottom provide that the solution and soils will flow generally outwards and away from the tool and into the bucket. The tool can also include a handle or handles and a portion around the upper rim to allow a lid to be connected. The lid can prevent foreign objects from falling into the straining tool during use of the tool or otherwise.

According to some aspects of the invention, a straining device for use at least partially within a bucket is provided. The straining device includes a body having a first end and opposite second end and including a plurality of apertures, a flange extending outwardly from the first end of the body, and a concave floor at the second end of the body and including at least one aperture to direct a liquid at least partially outwardly from the device. The flange is configured to interact with a portion of the bucket such that the floor of the device is positioned at least partially away from a floor of the bucket.

According to additional aspects of the invention, a straining device for use at least partially within a bucket to receive objects for pre-soaking of the objects is provided. The straining device includes a body having a first end and an opposite second end and a plurality of slots extending therebetween, and a flange extending outwardly radially from the first end and including at least one handle. The flange is configured to operatively connect to the bucket. A latch extends from the first end and capable of connecting the device to a lid, and a floor at the second end of the body and including at least one aperture therethrough. The device is configured to be positioned relative to the bucket such that the floor is spaced away from a floor of the bucket.

According to still additional aspects of the invention, a straining assembly for pre-soaking objects is provided. The assembly includes a bucket comprising a body, a floor, and a top rim. The assembly also includes a straining device at least partially positioned within the bucket. The straining device comprises a body having a first end and opposite second end and including a plurality of slots extending therebetween, a flange extending outwardly from the first end of the body, and a floor at the second end of the body and including at least one aperture. The flange is configured to engage the top rim of the bucket to position the straining device body within the bucket body such that the floor of the straining device is spaced away from the floor of the bucket.

### BRIEF DESCRIPTION OF THE DRAWINGS

FIG. 1 is an exploded view of a bucket, straining tool, and lid.

FIG. 2 is a perspective view of a straining tool according to aspects of the invention.

FIG. 3 is a front elevation view of the straining tool.

FIG. 4 is a top plan view of the straining tool.

FIG. 5 is a sectional view of the straining tool taken along lines 5-5 of FIG. 4.

FIG. 6 is a sectional view of the straining tool taken along lines 6-6 of FIG. 4.

FIG. 7 is an enlarged portion of the straining tool as taken from FIG. 6.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

The invention is directed towards an apparatus for use with washing or presoaking of objects. For example, the apparatus can be used with any number of objects, including, but not limited to, towels, cloths, hard surface items, textiles, wares, toys, or generally any other object that may be desired to have a presoak step before washing of the object. Therefore, the invention is to be thought of in a broad manner to include the aid in presoaking of any of the materials needed cleaned. For example, many objects that need to be cleaned include a step of presoaking prior to the cleaning. The cleaning, which can take place in an apparatus such as a washing machine, dishwasher, or the like, can be identified based on the object being cleaned. The presoak of the item allows for a better cleaning of said item. This includes the ability to remove stains and soils from the object such that the cleaning process in the cleaning apparatus does not include said such soils and/or stains. This will provide for a cleaner object after cleaning.

For example, in some industries, such as quick service restaurants, towels, cloths, or other textiles are used to clean surfaces. Soils, stains, and the like may become affixed to these textiles during the cleaning process. In order to fully or better clean the textiles, the textiles are positioned in a bucket with a solution for presoak of the item. The presoaking will aid to remove the soils and/or stains from the textiles before the textiles are moved to a cleaning apparatus, such as a washing machine. However, when moving the textiles from the presoak bucket to a cleaning apparatus, the soiled solution within the bucket can also be transferred to the cleaning apparatus. This can affect the cleaning operation, such as introducing the soils and/or stains in the solution to the cleaning process. Therefore, the invention provides a unique and advantageous device, method, and system for mitigating the transfer of soiled solution from a presoak bucket to a cleaning apparatus.

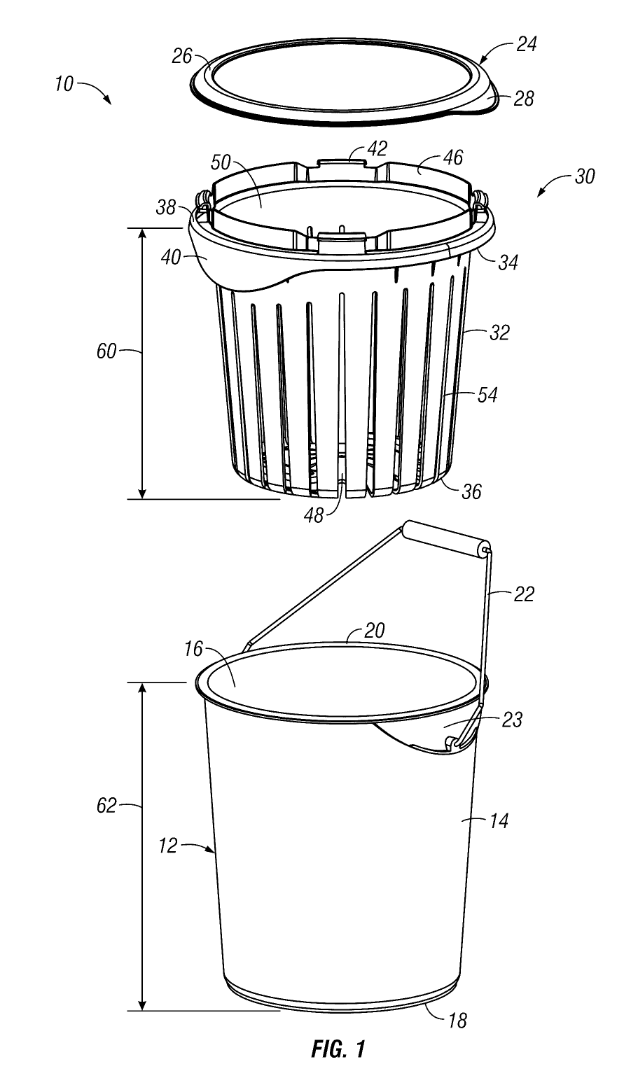

FIG. 1 is an exploded view of a straining or presoak assembly 10 according to aspects of the invention. The presoak process can include the use of a bucket 12. It should be noted that the term “bucket” is used generically and can be replaced by receptacle, pale, container, or the like, such that the term encompasses substantially any object that can contain and/or store an amount of presoaking solution. The bucket 12 shown in FIG. 1 is a standard bucket, including a bucket body 14 of upstanding walls. The bucket 12 is shown to be circular in nature, but the invention contemplates that any size and shape of buckets or other apparatuses can be used with the invention. The bucket 12 further includes an interior 16 defined by the upstanding walls of the body 14, a floor 18, and an annular rim or top 20. The bucket 12 as shown in the figures is a substantially solid and impermeable bucket for holding or containing a solution and/or objects for presoaking within said solution. Further aspects of the bucket 12 include a handle 22 connected at an extension 23 extending generally downward from the annular rim 20 of the bucket. It should further be appreciated that the bucket 12 includes a height, as identified by numeral 62 in FIG. 1. The height is measured on the interior and may be defined as the distance between the rim 20 and the interior floor 18 of the bucket. The interior 16 therefore can be defined by a volume quantified by the height as well as the other dimensions of the bucket.

Further aspects of the presoak assembly 10 as shown in FIG. 1 include a lid 24 for covering the bucket 12 and assembly 10. The lid 24 is a standard lid including an annular clasp portion 26 and a grip 28. The clasp portion 26 is configured to be contoured with the annular rim 20 of the bucket, so as to provide a cover for the bucket. The lid, therefore, prevents and/or mitigates something from entering the bucket when the lid is positioned on and attached to the bucket 12. Thus, the lid 24 may also be comprised of a substantially solid and/or impermeable material.

Additionally, a straining tool and/or device 30 is shown in the figure. The straining tool 30 is shown between the bucket 12 and the lid 24. The straining device 30 is configured to be positioned generally or at least partially within the bucket 12 such that presoak items can be placed within the straining device to be inserted within a solution stored within the interior 16 of the bucket 12. As will be understood, elements of the straining device 30 allow for the items positioned therein to be presoaked to aid in the removal of soils and/or stains, while providing for a removal from the bucket such that the soils and stains remain in the solution of the bucket such that they are not transferred to a cleaning apparatus. Furthermore, as shown in FIG. 1, the straining device 30 also includes a height, as identified by the numeral 60. The height of the straining device 30 can be either the interior or the exterior of the straining device 30. As will be understood, the height 60 of the straining device 30 is at least partially less than the height 62 of the bucket 12 such that when the straining tool 30 is positioned within the bucket 12, there will be at least some space between a floor 48 of the straining device 30 and the floor 18 of the bucket. For example, the straining device 30 can be suspended from the rim 20 of the bucket such that the straining device is not supported by the bucket floor 18. This is advantageous over the non-use of a straining device, as well as other straining devices that are positioned within a bucket such that they rest on the floor of the bucket.

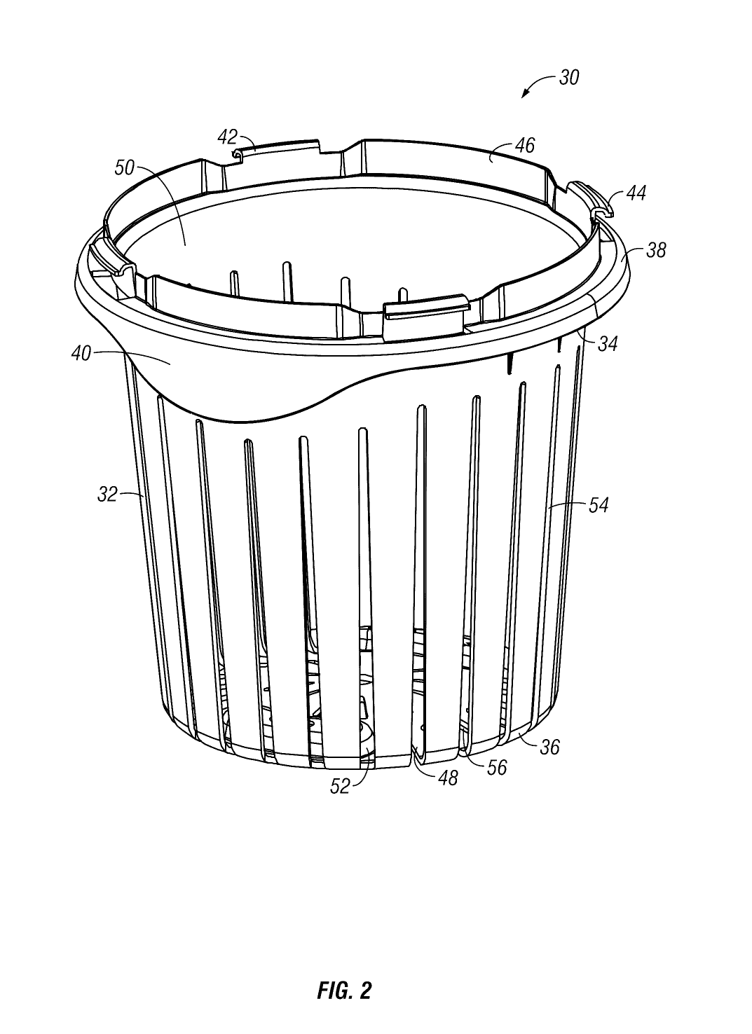

FIGS. 2-7 show aspects of the straining device 30 according to the invention. The straining device 30 comprises a body 32 extending between a first end 34 and the second end 36. The first end 34 may be known as the upper end of the body 32, while the second end 36 may also be known as the lower end of the body 32. As is shown through the figures, the body 32 is generally circular shaped and decreases in diameter from the first end 34 to the second end 36 of the body. This provides a shape of a frustum of a cone shape for the straining device body 32. However, it should be appreciated that other types of shapes, including cones, or other geometric shapes are contemplated and can be used to form the straining device body 32 of the invention. The shape of the straining device need not even be the same as the bucket 12. However, suspending or otherwise positioning the straining device 30 such that there is space between the floor 48 of the straining device 30 and the floor 18 of the bucket 12 is advantageous.

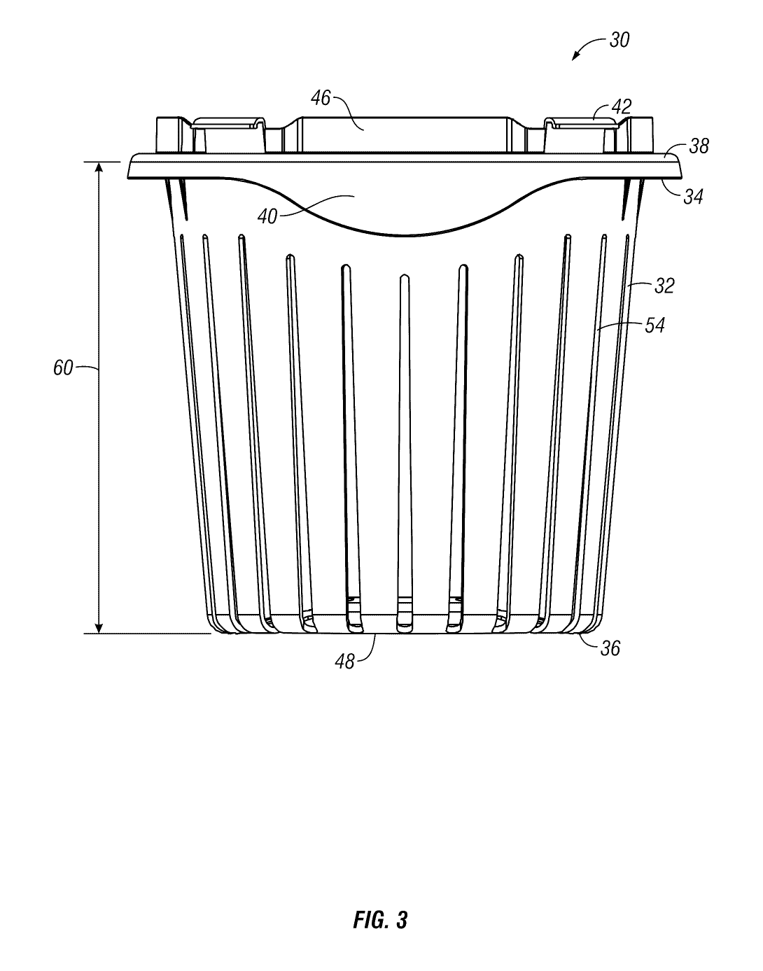

Positioned generally at the first end 34 of the straining device body 32 is an annular flange 38 extending transversely outwardly from the first end 34 of the body 32. While the term “annular” is used, it should be appreciated that the flange 38 generally matches the shape of the body 32, and therefore need not be circular. As shown best in FIGS. 3 and 5-7, the flange 38 may extend outwardly and partially downwardly, thus forming a canopy or an umbrella-type flange portion. The flange 38 is configured to be operatively positioned with the bucket 12, such as by resting an underside of the flange 38 on an upper portion of the rim 20 of the bucket 12. It is contemplated, but not required, that the flange 38 be contoured with a flange or rim 20 of a bucket for use therewith. Thus, it is contemplated that any shape of a bucket or receptacle device can be met by the straining device 30. Furthermore, while the flange 38 is shown to be canopied and/or umbrella in shape, it is to be appreciated that this not need be the case in embodiments of the invention. For example, the flange may extend in generally any manner from the first end 34 of the straining device body 32 such that the flange is able to interact with an upper rim of a bucket or receptacle to aid in holding the straining device 30 in place relative to the bucket or receptacle 12.

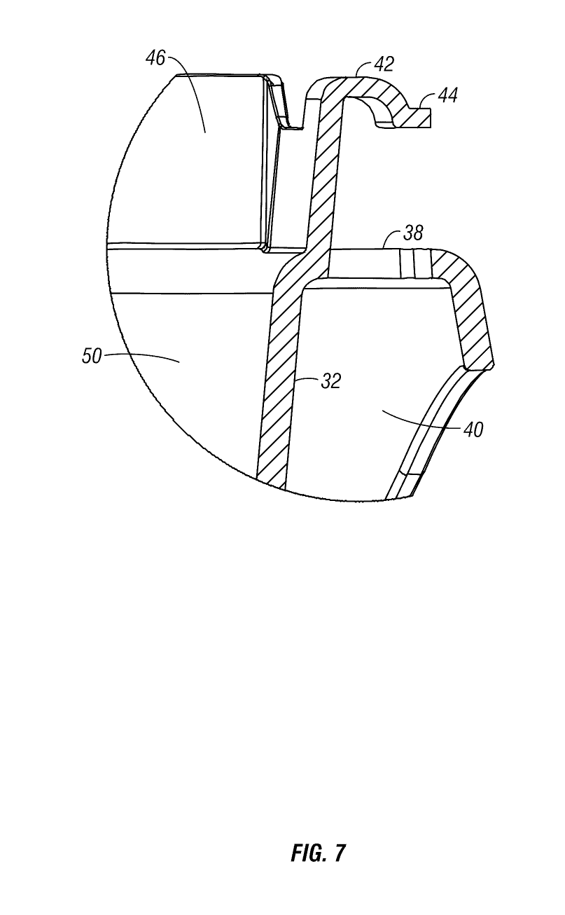

Also positioned generally at the flange 38 are one or more latches 42. A latch 42 is shown in FIG. 7 in an enlarged manner. The latch 42, as shown in FIG. 7, includes a flange 44 extending outwardly from the upstanding latch 44. The latch is configured to interact with a clasping portion of the lid 24 to allow for the attachment of the lid 24 directly to the straining device 30. Therefore, when the straining device is positioned within a bucket or receptacle, the lid can still be attached to the straining device to provide for closure of the bucket and straining device combination. While a particular latch 42 is shown in the figures, it should be appreciated that generally any type of latch or clasping mechanism may be included with the straining device 30 so as to allow for the releasable attachment of a lid or other covering apparatus for the straining device and/or bucket 12. The figures show a plurality of latches 42 radially positioned upwardly from the flange 38 of the straining device 30. However, the invention is not to be limited to particular types and numbers of latches, and can include generally any type thereof. In between the latches include an upstanding wall 46. The wall is to be used with the latches so as to provide a barrier such that when a lid is positioned and connected to the latches 44, any liquid solution or otherwise within the bucket and straining device will not be spilled, such as between the latches. The upward extending latches 42 and walls 46 provide for a sort of false wall and/or connection and spill prevention region of the straining device 30, as the connection rim of the bucket will be covered by the flange 38 of the straining device 30.

Still other aspects of the flange 38 include one or more handles 40 extending generally downward from the flange region 38. The handles 40, as shown through the figures, include portions extending further than the canopied portions of the flange lip. The handles allow for a user to grip the handle to remove the straining device 30 from the bucket 12 or other receptacle. The handles 40 may take any shape and number so as to allow for the removal of the straining device relative to the bucket 12.

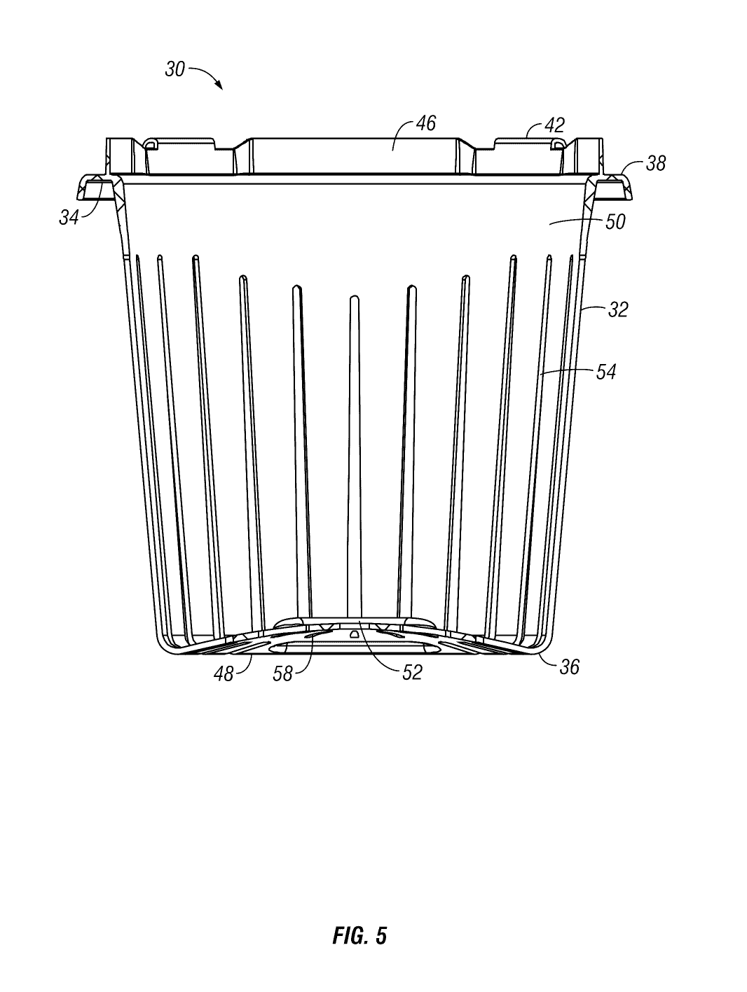

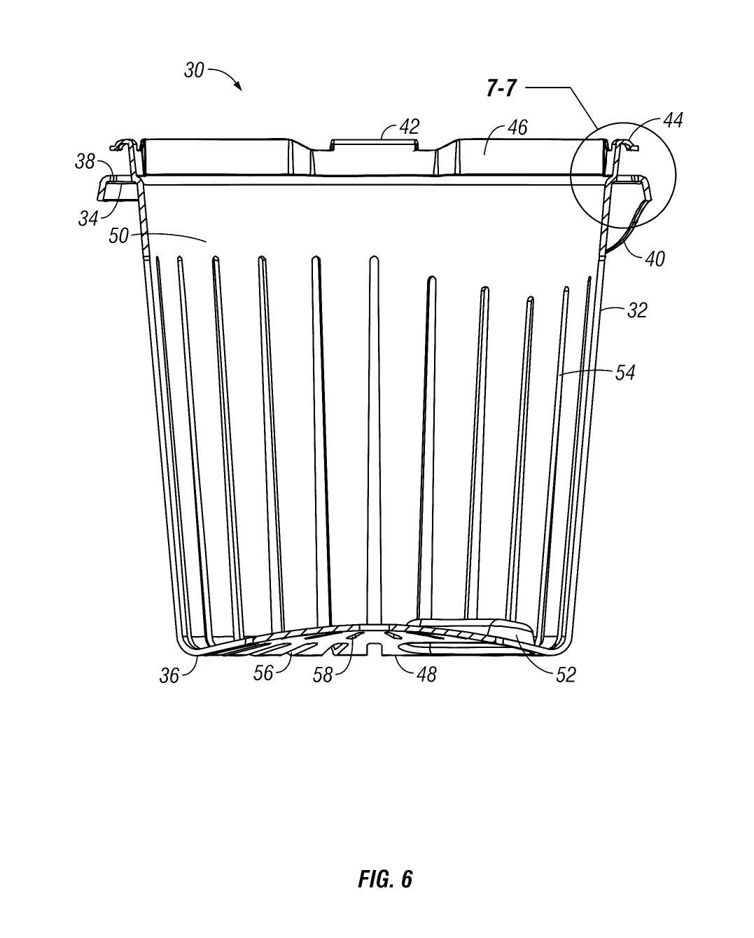

Positioned generally at the second end 36 of the body 32 of the straining device 30 is a floor 48. The floor 48, as shown in the FIGS. 5 and 6, is shown to be concave inwardly towards the interior 50 of the straining device 30. However, it should be appreciated that while the concave shape of the floor is provided, the floor need not be concave in all embodiments of the straining device 30, and can be substantially planar or take generally any other configuration.

The concave shape of the floor 48 allows for any soiled presoak solution within the interior 50 of the straining device 30 to be directed in a downward and outward manner such that it is displaced from within the interior 50 of the straining device 30 and into the bucket interior 16. For example, when the straining device 30 is removed from the bucket 12, the concave configuration of the floor 48 will aid in insuring that solid soils and stains removed from the items presoaked therein will be directed towards the bucket interior such that they will not be added to the cleaning apparatus. The down and outward shaped concave floor will direct the soiled solution away from the interior 50 of the device 30 and towards slots in the device.

To further aid in the evacuation of soils and stains within a used presoak solution from the interior 50 of the straining device body 32, a plurality of slots, apertures, or the like are positioned through the body and/or floor of the straining device 30. The figures show a plurality of slots 52 extending longitudinally and positioned radially through the straining device body 32. The slots 54 are shown of varying starting position and length. Furthermore, they are shown to be extending from varying distances from the first end 34 of the straining device body 32. Still further, it is shown that at least some of the slots 54 extending generally axially with the straining device body 32 will extend inwardly at the floor 48 to extend at least partially along or through the floor 48 of the straining device 30 and towards the axis thereof. It is to be appreciated that generally any configuration of apertures, slots, or the like be made in, around, and through the straining device body to allow for the soiled presoak solution to be expelled generally downwardly and/or outwardly from the straining device 30 and into the bucket or other receptacle 12.

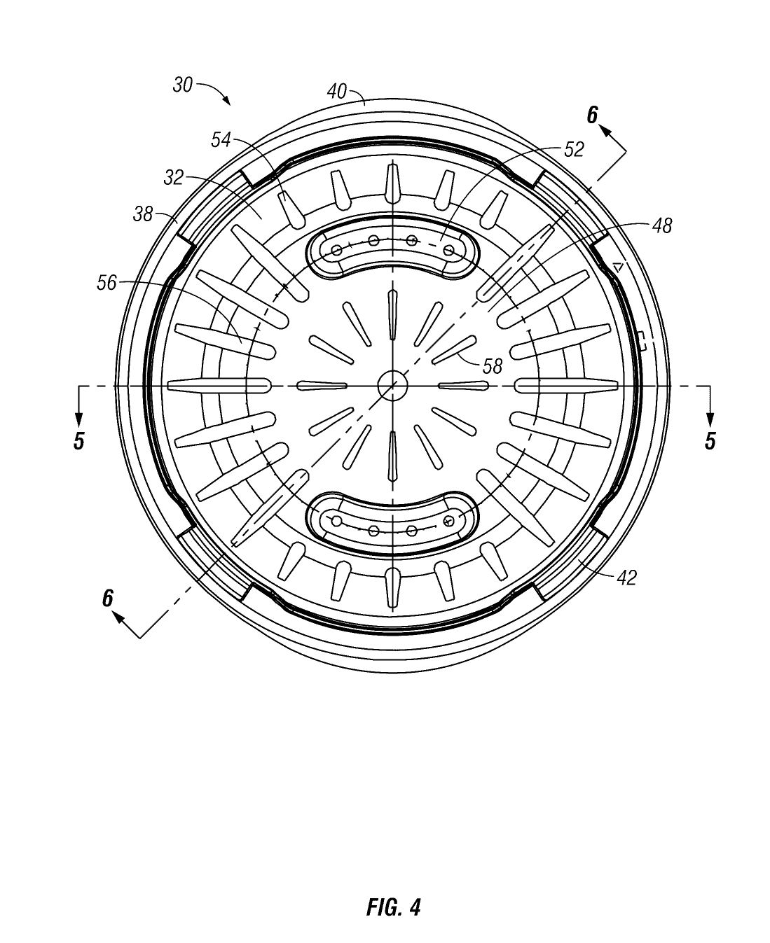

As shown in FIG. 4, the floor 48 may include one or more radially positioned floor slots 58 through at least a portion of the concaved portion of the floor 48. As mentioned, these slots on the concave portion will aid in directing the soiled presoak solution from within the interior 50 of the straining device 30 generally outwardly and downwardly and into the bucket or other receptacle. However, it should be appreciated that other types of slot and/or aperture configurations may be accomplish or even better the evacuation of the soiled solution therefrom, and is to be considered a part of the invention.

Furthermore, as is shown in FIG. 4, the floor may include one or more grip portions 52. The grip portions 52 are shown to be molded as part of the straining device body or floor. For example, as is shown in the figures, the grip portions comprise inwardly extending, mound shape portions extending inwardly from the floor 48. These grips are configured to allow a user to grip an underside of the straining device 30 when dumping the presoaked objects of the straining device 30 into a cleaning apparatus, as will be understood. Therefore, it is to be appreciated that the grips may be placed at a generally outwardly radius position from the axis of the straining device 30, but can be positioned generally anywhere such that a user is able to grip at or near the floor 48 of the straining device 30. Furthermore, it is to be appreciated that the grips need not be included in all embodiments of the straining device 30. For example, the concavity of the floor 48 of the straining device 30 may allow a user to achieve a grip to allow the unloading of the contents within the straining device 30. Still further, when the floor is not concave, a user may still be able to have enough grip without the use of the formed or molded grips therein to achieve unloading of the straining device 30.

In operation, the straining device 30 can be inserted into or with a bucket or other receptacle 12 prior to or after the addition of a presoak solution, such as the solution disclosed in U.S. Pat. No. 8,753,453, herein incorporated by reference in its entirety.

One or more items to be presoaked can then be added to the interior 50 of the strainer. Furthermore, the items can be added to a straining device 30 before placing the straining device 30 into the bucket 12, including when the bucket does or does not include the presoak solution.

The straining device 30 is positioned relative to the bucket 12 such that the underside of the annular flange 38 rests generally on the annular rim or top surface 20 of the bucket 12. Due to the height 60 of the straining device 30 being less than the height 62 of the bucket 12, there will be at least some distance between the floor 48 of the straining device 30 and the floor 18 of the bucket 12 so that the straining device 30 will be suspended within the bucket 12. The items in the straining device 30 are allowed to soak for an amount of time. Once the presoak is complete, the items being presoaked can be moved to a cleaning apparatus. For example, when the items are towels being presoaked, the towels can be moved to a washing machine. To aid in the easy transfer of the towels from the presoak solution to the washing machine without transferring any soils, stains, or other hard items removed from the towels during the presoak, the straining device 30 can be removed from the bucket 12. The handles 40 at the annular flange 38 of the straining device 30 allow for the easy removal of the straining device 30 from the bucket 12.

During removal of the straining device 30 from the bucket 12, any soiled solution within the straining device 30 will be directed out of the straining device 30 via the various slots 54, 56, 58. The combination and configuration of the slots of the straining device 30 will provide for quick straining of the soiled solution from the straining device 30. Therefore, once the straining device 30 has cleared from the bucket 12, the amount of soiled solution should be at a minimal within the straining device. Additional measures can take place, such as shaking, pressing, or the like to further remove soiled presoak solution from the items that have been presoaked.

The straining device 30 can then be used to dump the presoaked items directly into a washing machine or other cleaning apparatus without requiring touching of the items by the operator. This can be accomplished by providing that the operator utilize the grips 52 on the floor 48 of the straining device 30 in conjunction with the handles 40 around the annular flange 38 of the straining device 30. The combination of the grip and handle will allow a user to easily dump the presoaked items into a cleaning apparatus, wherein the cleaning apparatus can further clean the items. The straining device can then be repositioned in the bucket 12 for further use, can be reused, or it can be cleaned itself. Furthermore, when not in use, the lid 24 can be attached to the bucket 12 or the straining device 30 positioned within the bucket 12 to prevent any foreign objects from falling into the buckets 12.

Therefore, the numerous advantageous of the straining device 30 of the invention should be readily apparent to those skilled in the art. For example, the straining tool 30 allows for presoaking and straining of items, while reducing the amount of soiled solution that is passed to a cleaning apparatus. The device allows a customer or operator to soak items, while easily draining them to eliminate substantially all soiled solution from being poured into the cleaning apparatus. The design of the straining apparatus and the functionality of the apparatus can be used with generally any bucket or other receptacle in a quick and easy manner to provide such advantages. Still further, the use of the straining tool 30 of the invention allows for the presoaking and transfer of the presoaked items without directly touching any of the items or solution used to presoak. The design of the straining device 30 for conjunctive use with a bucket also allows that the handle 22 of the bucket can still be cleared so that any combination of bucket, straining device, and/or lid can be moved via the handle 22.

The straining device 30, as shown in the figures, comprises an integral, one-piece molded device comprising high density polyethylene (HDPE). The device can comprise a molded resin to allow for the items being soaked therein to be suspended above the floor of the bucket, allowing heavy soils to fall to the bottom of the bucket. Elevating the items being soaked aids in preventing stains from redepositing on the materials being soaked. Furthermore, use of the straining device aids in transferring the items to a washing machine or other collection device, along with the soiled solution to be drained and disposed of. All plastic molded parts would most likely be made from polypropylene or polyethylene and in some parts have a reinforced filler e.g. nylon, talc or “glass” (fiberglass).

The foregoing description has been presented for purposes of illustration in descriptions, and it is not intended to be an exhaustive list or to limit the invention to the precise forms disclosed. For example, the size and shape of the straining device may take generally any geometric form to correspond with a receptacle for use with presoaking one or more items. Furthermore, the walls of the body 32 of the straining device 30 may not be inclined inwardly and may be substantially parallel to one another. Still further, the various slots of the straining device may be altered or changed to allow for different types of soils and stains, including solid soils, to pass therethrough and into the bucket or receptacle for not adding to the cleaning apparatus. It is contemplated that other alternative process, systems, and assemblies obvious to those skilled in the art are to be considered part of the invention. It is to be understood that the invention includes numerous advantages, as has been shown and described.

What is claimed is:

1. A straining device for use at least partially within a bucket, the device comprising:
a body having a first end and opposite second end and including a plurality of apertures;
a flange extending outwardly from the first end of the body; and
a concave floor at the second end of the body and including at least one aperture to direct a liquid at least partially outwardly from the device;
wherein the flange is configured to interact with a portion of the bucket such that the floor of the device is positioned at least partially away from a floor of the bucket.

2. The straining device of claim 1, further comprising at least one handle extending from the flange.

3. The straining device of claim 2, further comprising at least one latch extending away from the flange and configured to connect with a lid for covering the straining device and bucket.

4. The straining device of claim 1, wherein the flange of the straining device is configured to be contoured with and covering a flange of the bucket.

5. The straining device of claim 1, wherein the plurality of apertures of the body of the straining device comprise slots extending at least partially between the first and second ends of the body.

6. The straining device of claim 5, wherein at least one of the slots extends at least partially through the floor of the straining device.

7. The straining device of claim 1, wherein the concave floor comprises a plurality of notches radially spaced about an axis of the straining device.

8. The straining device of claim 1, further comprising at least one grip formed in the floor of the straining device.

9. The straining device of claim 1, wherein the body comprises a frustum of a cone.

10. A straining device for use at least partially within a bucket to receive objects for pre-soaking of the objects, the straining device comprising:
a body having a first end and an opposite second end and a plurality of slots extending therebetween;
a flange extending outwardly radially from the first end and including at least one handle, the flange configured to operatively connect to the bucket;
a latch extending from the first end and capable of connecting the device to a lid; and
a floor at the second end of the body and including at least one aperture therethrough;
said device configured to be positioned relative to the bucket such that the floor is spaced away from a floor of the bucket.

11. The straining device of claim 10, further comprising at least one grip formed within the floor of the device.

12. The straining device of claim 11, wherein the floor of the device is concaved toward the interior of the body.

13. The straining device of claim 10, wherein the flange of the straining device is configured to rest on an end of the bucket.

14. The straining device of claim 13, wherein the flange is configured to at least partially surround the end of the bucket.

15. A straining assembly for pre-soaking objects, comprising:
a bucket comprising a body, a floor, and a top rim; and
a straining device at least partially positioned within the bucket, the straining device comprising:
a. a body having a first end and opposite second end and including a plurality of slots extending therebetween;
b. a flange extending outwardly from the first end of the body; and
c. a floor at the second end of the body and including at least one aperture;
wherein said flange is configured to engage the top rim of the bucket to position the straining device body within the bucket body such that the floor of the straining device is spaced away from the floor of the bucket.

16. The straining assembly of claim 15, wherein the straining device further comprises a latch at the flange of the straining device.

17. The straining assembly of claim 16, further comprising a lid configured to engage the latch to enclose the bucket and straining device.

18. The straining assembly of claim 17, wherein the straining device comprises at least one handle at the flange.

19. The straining assembly of claim 18, wherein the floor of the straining device comprises a grip.

20. The straining assembly of claim 20, wherein the straining device floor is concaved inwardly and including a plurality of slots radially spaced on the floor to direct liquid outward from the straining device body.
